(19) United States
(12) Patent Application Publication
(10) Pub. No.: US 2024/0429753 A1
(43) Pub. Date: Dec. 26, 2024

(54) Intermediate Receiver of Wireless Power Transfer

(71) Applicant: ohSnap, Inc., Apex, NC (US)

(72) Inventors: Peter James Diemer, Mocksville, NC (US); Dale Christopher Backus, Broadway, NC (US); David Paul Echem, Apex, NC (US); Eric Lucas Epstein, Durham, NC (US)

(21) Appl. No.: 18/747,940

(22) Filed: Jun. 19, 2024

Related U.S. Application Data
(60) Provisional application No. 63/509,194, filed on Jun. 20, 2023.

(51) Int. Cl. H02J 50/50; H02J 50/00; H02J 50/10; H02J 50/60

(52) U.S. Cl. CPC H02J 50/50; H02J 50/005; H02J 50/10; H02J 50/60

(57) ABSTRACT

In one embodiment, an intermediate receiver of wireless power transfer for coupling to a mobile electronic device is provided. The intermediate receiver includes an intermediate receiver coil configured in proximity to a primary receiver coil of the mobile electronic device. The primary receiver coil is configured to receive a primary amount of wireless power from a primary transmitter coil of a wireless power transmitter. The intermediate receiver coil is configured to receive an amount of wireless power from the primary transmitter coil that is less than the primary amount of wireless power received by the primary receive coil.

### PRIORITY

This application claims the benefit under 35 U.S.C. § 119 (e) of U.S. Provisional Patent Application No. 63/509,194, filed 20 Jun. 2023, which is incorporated herein by reference.

### TECHNICAL FIELD

This disclosure generally relates to wireless power transfer of electronic devices, and in particular relates to an intermediate receiver of wireless power transfer.

### BACKGROUND

Wireless power transfer of electrical energy involves sending electromagnetic energy from a transmitter to a receiver, where it is converted into useful forms of energy. Essentially, it functions like a transformer with transmitting and receiving coils that are not directly coupled but separated by a gap in between (typically air or other insulating materials). In the world of consumer electronics, mobile electronic devices such as mobile phones may be charged wirelessly without the need to plug in a physical cable to the device. However, the wireless charging process may be relatively inefficient compared to wired charging due to the loose coupling of the coils. Much of the electromagnetic energy transmitted by the charging coil may not be used by the receiver for various reasons-such as magnetic flux leakage (i.e., magnetic energy that is not contained within the system and “spills” out) or resistive heating from Eddy currents (which are induced in conductors when in the presence of an oscillating magnetic field). These losses of energy may reduce the overall efficiency of the charging system. Additionally, any heating that occurs in the process may slow down the charging rate (as devices must thermally throttle to prevent damage to components) and pose risks to users or objects in contact with the devices, potentially causing burns.

It is advantageous to recover the energy that does not contribute to the wireless charging of the mobile electronic device in order to increase productive energy transfer and mitigate unwanted heat generation.

### SUMMARY OF PARTICULAR EMBODIMENTS

Particular embodiments according to this disclosure present an intermediate receiver that may achieve greater power transfer efficiency by converting otherwise wasted energy from a wireless power transmitter into useable forms of energy. The energy that would otherwise be wasted, not coupled to a mobile electronic device, or not contribute to the charging of the mobile electronic device may be utilized in useful ways by placing the intermediate receiver close to the wireless power transmitter and the mobile electronic device during wireless charging. Instead of allowing the uncoupled energy that otherwise would not reach the phone due to being absorbed by other nearby materials, converted to heat, or looping back to the transmitter, it may be harvested by the intermediate receiver and used for different purposes such as for powering other electronic accessory devices that may be used in connection with the mobile electronic device. Moreover, energy harvesting of the intermediate receiver may be limited to a particular level to avoid interfering with the main power transmission between the mobile electronic device and the wireless power transmitter, thus ensuring proper charging of the mobile electronic device.

In particular embodiments, an intermediate receiver of wireless power transfer for coupling to a mobile electronic device is provided. The intermediate receiver includes an intermediate receiver coil configured in proximity to a primary receiver coil of the mobile electronic device. The primary receiver coil is configured to receive a primary amount of wireless power from a primary transmitter coil of a wireless power transmitter. The intermediate receiver coil is configured to receive an amount of wireless power from the primary transmitter coil that is less than the primary amount of wireless power received by the primary receiver coil.

In particular embodiments, the amount of wireless power received by the intermediate receiver coil is less than a threshold amount for triggering Foreign Object Detection (FOD) between the wireless power transmitter and the mobile electronic device.

In particular embodiments, the amount of wireless power received by the intermediate receiver coil is less than about 5% of the wireless power transmitted from the primary transmitter coil.

In particular embodiments, the amount of wireless power received by the intermediate receiver coil is less than about 750 mW.

In particular embodiments, the intermediate receiver coil is configured between the primary transmitter coil and the primary receiver coil.

In particular embodiments, the intermediate receiver coil is configured outside a perimeter of the primary receiver coil.

In particular embodiments, the intermediate receiver coil is configured concentrically with the primary receiver coil.

In particular embodiments, the intermediate receiver is integrated into one or more accessory devices for coupling to the mobile electronic device.

In particular embodiments, the accessory devices comprise one or more of a grip, a case, a wallet, or a stand.

In particular embodiments, the intermediate receiver further includes a flexible substrate having an adhesive and configured to be coupled to the mobile electronic device via the adhesive. The intermediate receiver coil is integrated into the flexible substrate.

In particular embodiments, the intermediate receiver further includes one or more electronic accessory devices electrically coupled to the intermediate receiver coil. One or more of the electronic accessory devices are configured to receive an electric power from the intermediate receiver coil.

In particular embodiments, the electronic accessory devices include one or more of a light-emitting diode (LED) element, a fan, a battery, a battery charger, a display, a device tracker, or a speaker.

In particular embodiments, one or more of the electronic accessory devices are further configured to be powered by a wireless power from the mobile electronic device.

In particular embodiments, the intermediate receiver includes a current limiting resistor electrically coupled between the intermediate receiver coil and one or more of the electronic accessory devices and configured to limit an electric current from the intermediate receiver coil to one or more of the electronic accessory devices.

In particular embodiments, the intermediate receiver includes a rectifier electrically coupled between the intermediate receiver coil and one or more of the electronic accessory devices and configured to convert an alternate electric current from the intermediate receiver coil into a direct electric current to be received by one or more of the electronic accessory devices.

In particular embodiments, the intermediate receiver includes a voltage regulator electrically coupled between the intermediate receiver coil and one or more of the electronic accessory devices and configured to adjust an electric voltage from the intermediate receiver coil to a constant value for one or more of the electronic accessory devices.

In particular embodiments, the intermediate receiver is further configured to receive an amount of wireless power from the primary receiver coil of the mobile electronic device during power sharing of the mobile electronic device.

In particular embodiments, an intermediate receiver of wireless power transfer for coupling to a mobile electronic device is provided. The intermediate receiver includes: an intermediate receiver coil configured in proximity to a primary receiver coil of the mobile electronic device, the primary receiver coil being configured to receive a primary amount of wireless power from a primary transmitter coil of a wireless power transmitter; and one or more electronic accessory devices electrically coupled to the intermediate receiver coil and configured to receive an electric power from the intermediate receiver coil. The intermediate receiver coil is configured to receive an amount of wireless power from the primary transmitter coil that is less than the primary amount of wireless power received by the primary receiver coil, and convert the received wireless power into the electric power to be received by one or more of the electronic accessory devices.

In particular embodiments, an intermediate receiver of wireless power transfer for coupling to a mobile electronic device is provided. The intermediate receiver includes an intermediate receiver coil configured in proximity to a primary receiver coil of the mobile electronic device, the primary receiver coil being configured to receive a primary amount of wireless power from a primary transmitter coil of a wireless power transmitter; and a base that receives the intermediate receiver coil. The intermediate receiver coil is configured to receive an amount of wireless power from the primary transmitter coil that is less than the primary amount of wireless power received by the primary receiver coil. The base is configured to be integrated into an accessory device for coupling to the mobile electronic device.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system, and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example mobile electronic device and an example wireless power transmitter;

FIG. 2 illustrates an example circuit diagram of a primary receiver coil of the mobile electronic device and a primary transmitter coil of the wireless power transmitter;

FIG. 3 illustrates an example intermediate receiver, which is positioned between the mobile electronic device and the wireless power transmitter;

FIG. 4 illustrates an example circuit diagram of an intermediate receiver coil of the intermediate receiver, which is positioned in proximity to the primary receiver coil and the primary transmitter coil;

FIG. 5 illustrates an example intermediate receiver with the intermediate receiver coil received in a base of the intermediate receiver;

FIG. 6 illustrates an example intermediate receiver positioned on top of the wireless power transmitter during wireless charging;

FIG. 7 illustrates an example circuit diagram of the intermediate receiver coil connected to one or more electronic accessory devices and circuit components.

FIGS. 8 and 8A illustrate an example intermediate receiver having a light-emitting diode (LED) element and/or a current-limiting resistor connected to the intermediate receiver coil.

FIGS. 9 and 10 illustrate a working example of the intermediate receiver coupled to the back of the mobile electronic device.

FIG. 11 illustrates an example intermediate receiver, which is coupled to the mobile electronic device.

FIG. 12 illustrates an example circuit diagram of an intermediate receiver coil of the intermediate receiver, which is positioned in proximity to the primary receiver coil of the mobile electronic device.

### DESCRIPTION OF EXAMPLE EMBODIMENTS

Particular embodiments of this disclosure are directed to an intermediate receiver of wireless power transfer, which may include an intermediate receiver coil configured to capture an amount of magnetic flux from a wireless power transmitter and convert it into electric power. This way, energy that does not contribute to charging the mobile electronic device may be harvested by the intermediate receiver to achieve power usage with greater efficiency while maintaining proper charging of the mobile electronic device.

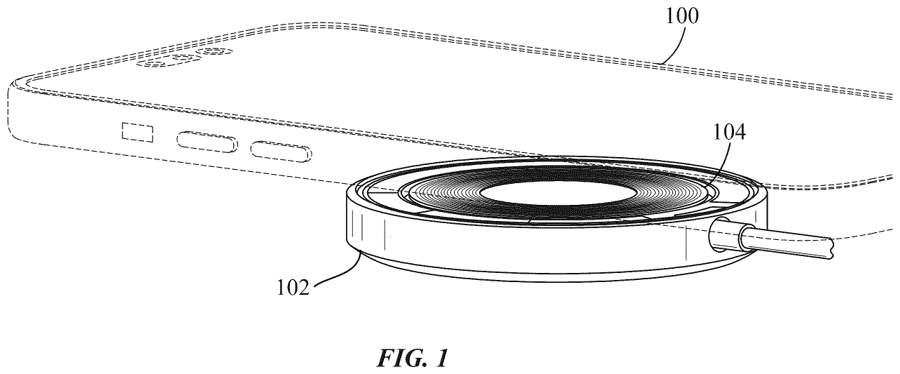

FIG. 1 illustrates an example mobile electronic device 100 and an example wireless power transmitter 102 during wireless charging. Although the mobile electronic device 100 and the wireless power transmitter 102 are illustrated in the figures as particular devices with particular shapes, sizes, and configurations in a particular manner, this disclosure contemplates any mobile electronic devices and any wireless power transmitters with any suitable shapes, sizes, and configurations in any suitable manner. As an example and not by way of limitation, the mobile electronic device 100 may be a smartphone, a cellular telephone, a tablet computer, a laptop computer, a wearable electronic device, a digital media player, and other suitable mobile electronic devices. As an example and not by way of limitation, the wireless power transmitter 102 may be a wireless charging base, a wireless charging dock, a wireless charging pad, a wireless charging platform, and other suitable wireless power transmitters, which, for example, may be a standalone device or incorporated into other charging devices or systems such as incorporated into a vehicle-mounted charging system.

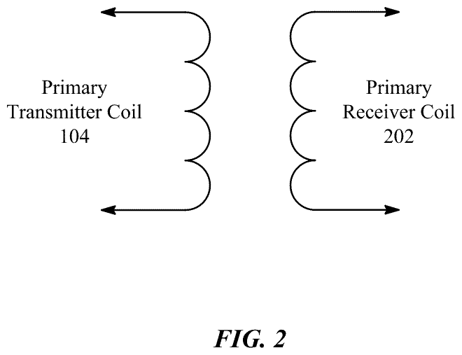

In particular embodiments, as illustrated, the mobile electronic device 100 may be placed on or in proximity to the wireless power transmitter 102 during wireless charging to receive wireless power from the wireless power transmitter 102. In particular embodiments, the wireless power transmitter 102 may be an alternating current (AC) charging base station that is configured to produce AC signals. As an example and not by way of limitation, the wireless power transmitter 102 may be connected to an AC power source such as a household power source, a vehicle-mounted power source, or other suitable power sources. As an example and not by way of limitation, if desired, the wireless power transmitter 102 may be connected to a direct current (DC) power source such as a battery and configured to convert the received DC power into AC signals. In particular embodiments, the wireless power transmitter 102 may include a primary transmitter coil 104, which may generate an oscillating magnetic or electromagnetic field when energized based on the received electric power from the power source. To be powered by the wireless power transmitter 102, in particular embodiments, the mobile electronic device 100 may include a primary receiver coil (e.g., the primary receiver coil 202 of FIG. 2), which, for example, may be integrated inside the body of the mobile electronic device 100 and configured to capture the magnetic field generated by the primary transmitter coil 104 of the wireless power transmitter 102 in order to allow wireless charging of the mobile electronic device 100.

FIG. 2 illustrates an example circuit diagram of the primary transmitter coil 104 of the wireless power transmitter 102 and the primary receiver coil 202 of the mobile electronic device 100. In particular embodiments, for effectively charging the mobile electronic device 100 through the wireless power transmitter 102, the primary receiver coil 202 may be placed in proximity to and substantially in alignment with (such as substantially concentric with or overlap with) the primary transmitter coil 104 such that the primary receiver coil 202 is substantially or entirely exposed to the magnetic field generated by the energized primary transmitter coil 104. In particular embodiments, during wireless charging, the primary receiver coil 202 may be configured to capture a substantial amount, if not all, of the generated magnetic field, which may in turn induce an alternating current in the primary receiver coil 202, thereby wireless charging one or more batteries or other suitable power sources of the mobile electronic device 100 that are electrically coupled to the primary receiver coil 202. This may generally be known in the industry as magnetic induction charging. Example specifications of such wireless charging technology may include QI, QI-2, and other suitable wireless charging specifications, which may ensure compatibility across different types and configurations of devices. Efficient charging typically requires close proximity and proper alignment between the primary transmitter coil of the wireless power transmitter and the primary receiver coil of the mobile electronic device. However, in practice, the primary transmitter coil and the primary receiver coil may not always be tightly coupled. For example, there may be space between the two primary coils, or it may be difficult to accurately align the two primary coils. Moreover, energy may be wasted or otherwise not captured by the primary receiver coil due to various factors, including but not limited to magnetic flux leakage, resistive heating caused by Eddy currents, and so on. Therefore, a solution is desired to achieve greater efficiency in harvesting the transmitted wireless power and converting it into useable energy.

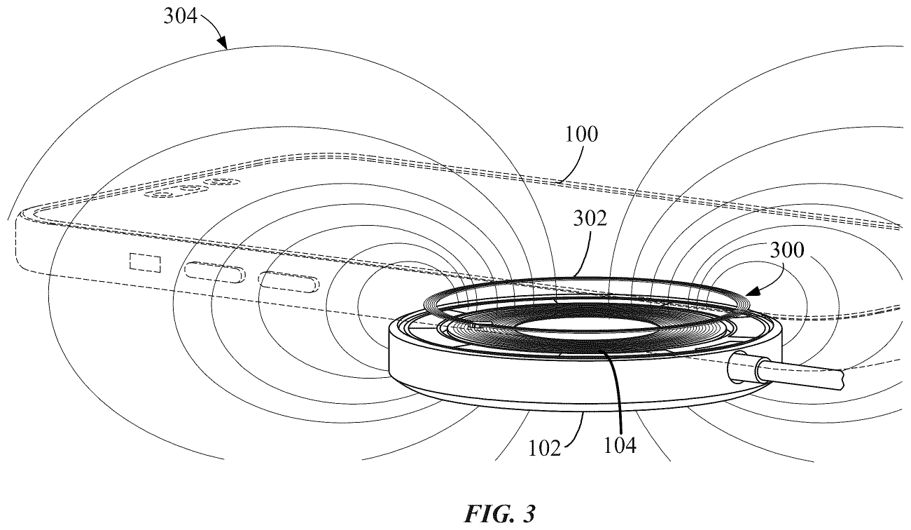

FIG. 3 illustrates an intermediate receiver 300 in accordance with an embodiment of this disclosure. In particular embodiments, the intermediate receiver 300 may be configured to harvest the energy that would otherwise be wasted or not captured by the primary receiver coil 202 of the mobile electronic device 100 and convert it into useable electric power without affecting the main charging event between the mobile electronic device 100 and the wireless power transmitter 102, such as triggering Foreign Object Detection (FOD) by the wireless power transmitter 102 which may cause the wireless power transmitter 102 to reduce or cease output. As an example and not by way of limitation, as already discussed, during the main charging event of the mobile electronic device 100, as electric current passes through the wireless power transmitter 102, it may generate oscillating magnetic flux 304 (shown schematically) via the primary transmitter coil 104, thus creating an alternating current in the primary receiver coil 202 of the mobile electronic device 100 (e.g., through induction, resonant induction, or other suitable methods). However, in reality, not all of the magnetic flux 304 emitted from the primary transmitter coil 104 may be coupled to or captured by the primary receiver coil 202, which may be referred to in this disclosure as uncoupled magnetic flux. This may occur for a number of reasons. As an example and not by way of limitation, some of the magnetic flux 304 may not directly extend to the primary receiver coil 202 but instead may loop back to the primary transmitter coil 104. As an example and not by way of limitation, some of the magnetic flux 304 may be undesirably absorbed by parasitic materials such as metal materials in the near vicinity of the primary receiver coil 202 and the primary transmitter coil 104. As an example and not by way of limitation, some of the magnetic flux 304 may be wasted due to the standoff distance between the primary receiver coil 202 and the primary transmitter coil 104.

In particular embodiments, the intermediate receiver 300 may include an intermediate receiver coil 302, which may be configured to harvest the uncoupled magnetic flux from the primary transmitter coil 104 that does not contribute towards wireless charging of the mobile electronic device 100. In particular embodiments, the intermediate receiver 300 may be configured to passively receive the uncoupled magnetic flux from the primary transmitter coil 104 to avoid disrupting the main charging event of the mobile electronic device 100. Alternatively or additionally, in particular embodiments, the intermediate receiver 300 may be configured as an active participant that actively intercepts the magnetic flux from the wireless power transmitter 102. As an example and not by way of limitation, the intermediate receiver 300 may be in communication with the wireless power transmitter 102 to negotiate power input and output, thereby avoiding triggering FOD. As an example and not by way of limitation, the amount of wireless power that may be received by the intermediate receiver 300—or, in other words, the amount of power that is determined as being “lost” between the wireless power transmitter 102 and the mobile electronic device 100—may be detected, monitored, and adjusted as needed to avoid triggering FOD. Moreover, in particular embodiments, the intermediate receiver 300 may convert this uncoupled magnetic flux into useable electric power, which, for example, may be used to power other electronic devices such as light-emitting diode (LED) elements, fans, batteries, battery chargers, displays, device trackers, speakers, air tags, or other suitable electronic devices associated with the mobile electronic device 100.

In particular embodiments, as illustrated, the intermediate receiver 300 may be configured to be coupled to the mobile electronic device 100 at a position in proximity to the primary receiver coil 202 of the mobile electronic device 100. In particular embodiments, the intermediate receiver 300 may be positioned near the primary transmitter coil 104 of the wireless power transmitter 102 during wireless charging. In particular embodiments, the intermediate receiver 300 may be configured between the mobile electronic device 100 and the wireless power transmitter 102 during wireless charging, for example, such as between the primary receiver coil 202 of the mobile electronic device 100 and the primary transmitter coil 104 of the wireless power transmitter 102. In particular embodiments, the intermediate receiver 300 may be coupled to the back side of the mobile electronic device 100 that faces the wireless power transmitter 102 during wireless charging. As an example and not by way of limitation, the intermediate receiver 300 may be coupled to the back side of the mobile electronic device 100 using a magnet, an adhesive, etc.

Implementation of the intermediate receiver 300 may vary across embodiments. In particular embodiments, the intermediate receiver 300 may be implemented as a standalone accessory that may be coupled to the mobile electronic device 100. As an example and not by way of limitation, the intermediate receiver 300 may be configured as a sticker-based device with a flexible substrate that is adherable to the back side of the mobile electronic device 100 via an adhesive, and into which the intermediate receiver coil 302 may be integrated or embedded. In particular embodiments, the intermediate receiver 300 may be coupled to or integrated into an accessory device associated with the mobile electronic device 100, for example, such as a grip, a case, a wallet, a stand, or other suitable accessories for coupling to the mobile electronic device 100.

In particular embodiments, the intermediate receiver 300 may be compatible with particular brands, manufacturers, or models of mobile electronic devices and wireless power transmitters. As an example and not by way of limitation, the intermediate receiver 300 may be compatible with an APPLE device (e.g., an IPHONE), an ANDROID device, and other suitable devices. As an example and not by way of limitation, the intermediate receiver 300 may be universally compatible with multiple (or all) brands, manufacturers, and models (e.g., both APPLE and ANDROID devices). In particular embodiments, the intermediate receiver 300 may be compliant with particular wireless power transmission specifications such as QI, QI-2, and other suitable specifications. In particular embodiments, the intermediate receiver 300 may be compliant with particular power connector specifications such as APPLE MAGSAFE.

The dimension of the intermediate receiver coil 302 of the intermediate receiver 300 may vary across embodiments. In particular embodiments, the intermediate receiver coil 302 may have an outer diameter and an inner diameter. In particular embodiments, the outer diameter of the intermediate receiver coil 302 may be larger than the outer diameter of the primary receiver coil 202 or the primary transmitter coil 104. As an example and not by way of limitation, the intermediate receiver coil 302 may have a sufficiently large outer diameter in order to minimize the overlap in the radial direction with the primary receiver coil 202 and/or the primary transmitter coil 104, thus limiting interference with the wireless charging of the mobile electronic device 100. Alternatively or additionally, the intermediate receiver coil 302 may have a sufficiently large inner diameter to minimize the radial overlap with the primary receiver coil 202 or the primary transmitter coil 104. In other words, in particular embodiments, the intermediate receiver coil 302 may radially reside outside the perimeter of the primary receiver coil 202 and/or the primary transmitter coil 104 in order to lessen the magnetic flux that the intermediate receiver coil 302 would intercept, avoiding interfering with the main charging event of the mobile electronic device 100.

In particular embodiments, the outer or inner diameter of the intermediate receiver coil 302 may be smaller than that of the primary receiver coil 202 and/or the primary transmitter coil 104 so that the intermediate receiver coil 302 may be located inside the periphery of the primary receiver coil 202 or the primary transmitter coil 104. This may similarly help limit the amount of energy the intermediate receiver coil 302 would harvest from the wireless power transmitter 102.

In particular embodiments, when used in connection with the APPLE MAGSAFE magnetic array charger in which the specified inner diameter for the magnet array is 46 mm and the outer diameter for the magnet array is 54.1 mm, the outer diameter of the intermediate receiver coil 302 may be about 75 mm. Alternatively or additionally, the inner diameter of the intermediate receiver coil 302 may be about 36 mm.

In particular embodiments, the intermediate receiver coil 302 may have a thickness small enough to avoid substantially interfering with wireless charging. As an example and not by way of limitation, the overall thickness of the intermediate receiver coil 302 or the intermediate receiver 300 as a whole may correspond to the maximum distance possible to maintain wireless charging between the wireless power transmitter 102 and the mobile electronic device 100, which, for example, may be about 10 mm or less. As an example and not by way of limitation, when used in connection with an extended-range wireless power transmitter that allows for an increased effective charging distance between the wireless power transmitter and the mobile electronic device, the overall thickness of the intermediate receiver coil 302 or the intermediate receiver 300 as a whole may correspondingly increase, for example, to a value greater than 10 mm, such as in the range of 25 mm to 30 mm.

In particular embodiments, as illustrated, the intermediate receiver coil 302 may be configured concentrically with the primary receiver coil 202 of the mobile electronic device 100 and/or the primary transmitter coil 104 of the wireless power transmitter 102. In particular embodiments, although not illustrated, the intermediate receiver coil 302 may be configured off-axis relative to the primary receiver coil 202 and/or the primary transmitter coil 104. As an example and not by way of limitation, the intermediate receiver coil 302 may be positioned to occupy the space outside the greatest flux density of the wireless power transmitter 102 but may still intercept magnetic flux leakage on the periphery.

The shape of the intermediate receiver coil 302 may vary across embodiments. In particular embodiments, as illustrated, the intermediate receiver coil 302 may generally be circular. In particular embodiments, although not illustrated, the intermediate receiver coil 302 may be elliptical, triangular, rectangular, polygonal, non-polygonal, irregular in shape, etc. In particular embodiments, the intermediate receiver coil 302 may be configured as a closed loop having any suitable shapes. Moreover, the shape of the intermediate receiver 300 may vary across embodiments and may or may not be similar to the shape of the intermediate receiver coil 302. In particular embodiments, as illustrated, the intermediate receiver 300 may generally be circular. In particular embodiments, although not illustrated, the intermediate receiver 300 may be elliptical, triangular, rectangular, polygonal, non-polygonal, irregular in shape, etc.

In particular embodiments, although not illustrated, the intermediate receiver may include multiple intermediate receiver coils, which, for example, may have the same, similar, or different dimensions relative to one another. As an example and not by way of limitation, the intermediate receiver coils may be configured to be coupled with one another in series or in parallel—in this case, for example, the intermediate receiver coils may be referred to as a secondary coil, a tertiary coil, etc. As an example and not by way of limitation, one or more of the intermediate receiver coils may have a diameter that is significantly smaller than the diameter of the primary receiver coil of the mobile electronic device or the primary transmitter coil of the power transmitter. As an example and not by way of limitation, one or more of the intermediated receiver coils may be arranged near the perimeter of the primary receiver coil or the primary transmitter coil in order to harvest the uncoupled magnetic flux between the two primary coils. In particular embodiments, one or more of the intermediate receiver coils may be configured to power one or more electronic accessory devices. As an example and not by way of limitation, one or more of the intermediate receiver coils may each be configured to independently power an electronic accessory device. Alternatively or additionally, as an example and not by way of limitation, one or more of the intermediate receiver coils may be configured to collectively power a single electronic accessory device. Although this disclosure describes an intermediate receiver having an intermediate receiver coil in a particular manner, this disclosure contemplates intermediate receivers having intermediate receiver coils in any suitable manner.

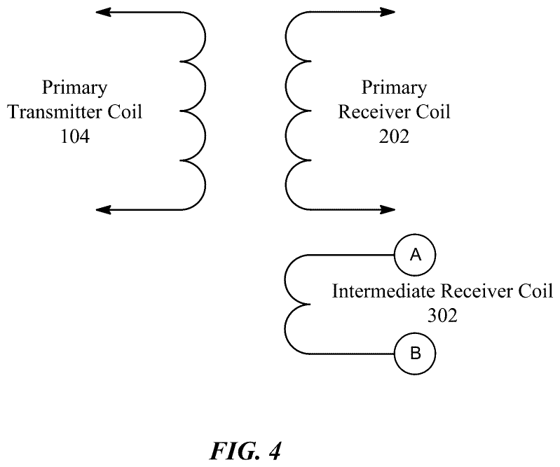

FIG. 4 illustrates an example circuit diagram of the intermediate receiver coil 302, which is positioned in proximity to the primary transmitter coil 104 of the wireless power transmitter 102 and the primary receiver coil 202 of the mobile electronic device 100. In particular embodiments, wireless charging of the mobile electronic device 100 may be implemented via the primary transmitter coil 104 and the primary receiver coil 202 such that most of the magnetic flux 304 generated by the primary transmitter coil 104 is captured by the primary receiver coil 202. In particular embodiments, the intermediate receiver coil 302 may be configured to be wirelessly coupled to the primary transmitter coil 104 in order to harvest magnetic flux from the primary transmitter coil 104 of the wireless power transmitter 102. In particular embodiments, the amount of energy received by the intermediate receiver coil 302 may be relatively small. As an example and not by way of limitation, the amount of wireless power gathered by the intermediate receiver coil 302 from the primary transmitter coil 104 may be less than, or significantly less than, the amount of wireless power received by the primary receiver coil 202. This way, energy harvesting by the intermediate receiver coil 302 may be implemented without substantively interfering with the charging event of the mobile electronic device—e.g., without triggering FOD during wireless charging. FOD may generally refer to a system's ability to identify and respond to the presence of unintended metallic or conductive objects placed between a charging device (e.g., transmitter) and a device being charged (e.g., receiver). Specifically, for example, during wireless charging, information may be exchanged between the transmitter and the receiver, and a decision may be made about the foreign object presence based on the exchanged information. For example, in response to determining that there exists an information mismatch between the transmitter and the receiver, which indicates a possible presence of foreign object, power output from the transmitter may be adjusted-such as by reducing the output to a lower level or suspending power transmission entirely—to prevent any potential hazards like heating of the foreign object. In order to avoid triggering FOD and maintain proper energy transmission between the primary transmitter coil 104 and the primary receiver coil 202, in particular embodiments, the intermediate receiver coil 302 may be configured to intercept less than the threshold amount of power output from the primary transmitter coil 104 that would trigger FOD. As an example and not by way of limitation, the intermediate receiver coil 302 may be configured to intercept less than about 5%, less than about 4%, less than about 3%, less than about 2%, or less than about 1% of the total power output from the primary transmitter coil 104. As an example and not by way of limitation, when used under the QI-2 specification where the maximum output power from the primary transmitter coil 104 is 15 W, the energy gathered by the intermediate receiver coil 302 may be less than about 750 mW, less than about 600 mW, less than about 450 mW, less than about 300 mW, or less than about 150 mW. In particular embodiments, the percentage value of energy gathered by the intermediate receiver coil 302 may depend on the maximum level of power output from the primary transmitter coil 104. As an example and not by way of limitation, as the maximum power level from the primary transmitter coil 104 increases, the percentage value of power harvested by the intermediate receiver coil 302 may decrease such that the maximum allowed wattage may remain relatively the same. Conversely, as an example and not by way of limitation, as the maximum power level from the primary transmitter coil 104 decreases, the percentage value of power harvested by the intermediate receiver coil 302 may increase such that the maximum allowed wattage may remain relatively the same.

In particular embodiments, the amount of wireless power gathered by the intermediate receiver 300 from the primary transmitter coil 104 may depend on the inductance of the intermediate receiver coil 302. As an example and not by way of limitation, the inductance of the intermediate receiver coil 302 may be significantly smaller than that of the primary receiver coil 202. In particular embodiments, the inductance of the intermediate receiver coil 302 and, thus, its coupling to the primary transmitter coil 104, may be tuned via the area or number of wire loops in the intermediate receiver coil 302. This way, the desired proportion of intercepted energy may be raised or lowered with the increasing or decreasing of the coupling, respectively. As an example and not by way of limitation, if a greater inductance of the intermediate receiver coil 302 is desired, the number of wire loops may be increased to enhance the efficiency and/or effectiveness of the coupling. Conversely, as an example and not by way of limitation, to produce a weaker induction effect, the number of wire loops of the intermediate receiver coil 302 may be reduced to limit the power that may be intercepted by the intermediate receiver coil 302. This may help prevent the wireless power transmitter 102 from detecting a rise in output power without the mobile electronic device 100 indicating an associated increase in received power. Additionally or alternatively, in particular embodiments, one or more capacitors may be provided-such as by electrically coupling to the intermediate receiver coil 302—to adjust the inductance of the intermediate receiver 300.

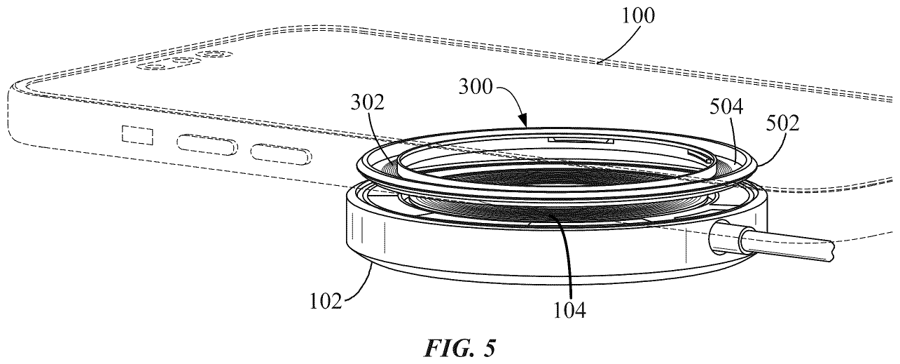

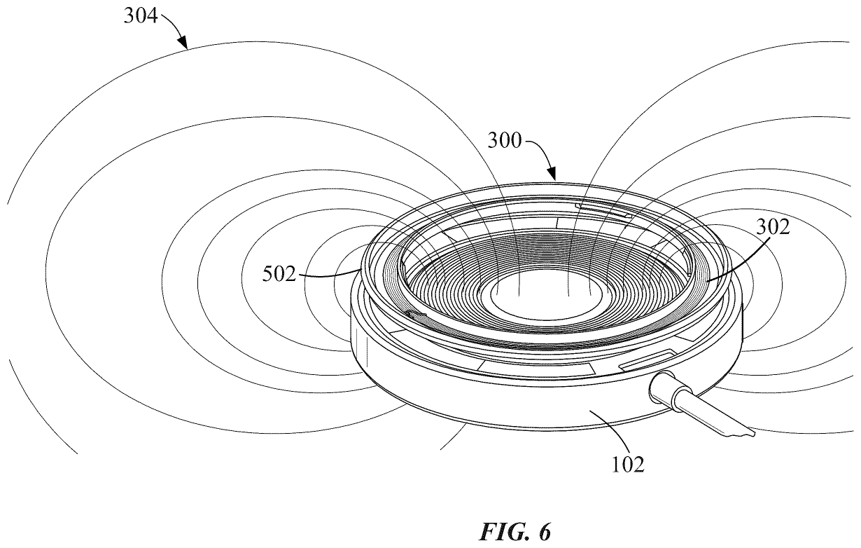

FIGS. 5 and 6 illustrate the intermediate receiver 300 in accordance with an embodiment of this disclosure. In particular embodiments, the intermediate receiver 300 may include a base 502, which may be configured to receive or house the intermediate receiver coil 302. As an example and not by way of limitation, as illustrated, the base 502 may be configured as a ring having an annular groove 504 for containing the intermediate receiver coil 302 therein. While described and illustrated as a ring, other suitable shapes and structures of the base 502 are also envisioned by this disclosure to accommodate the intermediate receiver coil 302. As an example and not by way of limitation, the base 502 may be elliptical, triangular, rectangular, polygonal, non-polygonal, irregular in shape, etc.

In particular embodiments, the base 502 may be integrated into or coupled to an accessory device associated with the mobile electronic device 100, for example, such as a grip, a case, a wallet, a stand, or other suitable accessories. As an example and not by way of limitation, a case may be a protective casing substantially covering the back side of the mobile electronic device 100 to provide physical protection for the mobile electronic device 100. In this case, for example, the base 502 may be integrated into or coupled to the case body (e.g., via an adhesive, a magnet, etc.). As an example and not by way of limitation, a grip may be a deployable structure for coupling to the back side of the mobile electronic device 100 or to a case of the mobile electronic device 100, allowing a user to easily grasp the mobile electronic device 100 via the grip. In this scenario, for example, the grip may include a base frame for attaching to the back of the mobile electronic device 100, and the base 502 having the intermediate receiver coil 302 may be integrated into the base frame of the grip.

In particular embodiments, the base 502 may be made of non-conductive materials (such as plastic) or non-ferrous metals (such as aluminum, copper, magnesium alloy, etc.) to avoid interfering with the power harvesting of the intermediate receiver coil 302 from the wireless power transmitter 102 or the charging event of the mobile electronic device 100.

In particular embodiments, the base 502 may be configured to house other circuit components or small electronic accessory devices that may be coupled to the intermediate receiver coil 302 for power supply, such as LED elements, batteries, battery chargers, displays, device trackers, speakers, air tags, or other suitable electronic devices, which will be further explained below.

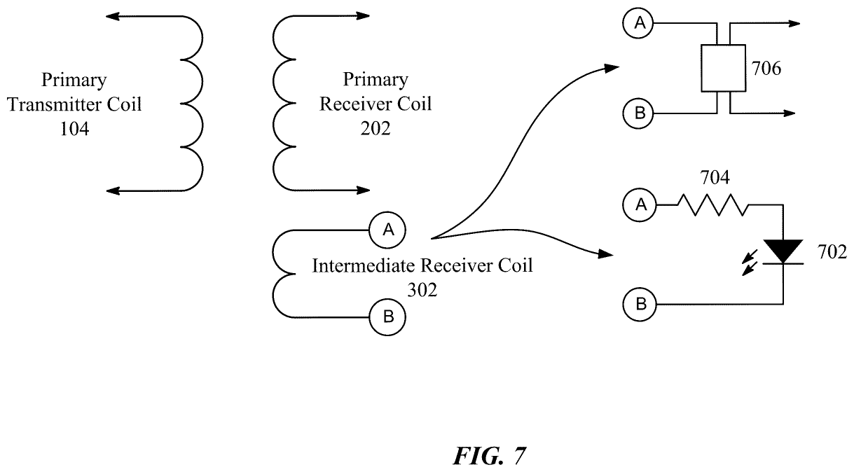

FIG. 7 illustrates an example circuit diagram of the intermediate receiver coil 302, which is positioned in proximity to the primary transmitter coil 104 and the primary receiver coil 202 and electrically coupled to one or more electronic accessory devices. In particular embodiments, the intermediate receiver coil 302 may be electrically coupled to an LED element 702 and a current-limiting resistor 704, which may, for example, be connected in line with the LED element 702. As an example and not by way of limitation, the LED element 702 may be configured to provide a visual notification to a user, indicating, for example, a charging status of the intermediate receiver coil 302, a charging status of the mobile electronic device 100, an operation status of the mobile electronic device 100, and other suitable information associated with operations of the intermediate receiver 300 and the mobile electronic device 100. In particular embodiments, the LED element 702 may provide the added benefit of interrupting loops of induced electrical current, thereby reducing the overall Eddy current effect. In particular embodiments, the current-limiting resistor 704 may be configured to govern the electric current generated by the intermediate receiver coil 302. As an example and not by way of limitation, the current-limiting resistor 704 may function as a current regulator to limit the power captured by the intermediate receiver coil 302 in order to provide current protection for the LED element 702 or other electronic accessory devices connected to the intermediate receiver coil 302. As an example and not by way of limitation, the current-limiting resistor 704 may also help prevent the intermediate receiver coil 302 from interfering with the charging operation of the mobile electronic device 100. This may be useful in balancing the amount of power received by the intermediate receiver coil 302 to prevent the wireless power transmitter 102 from throttling back if it detects too great of a difference between output power and received power (e.g., to avoid triggering FOD).

In particular embodiments, the intermediate receiver coil 302 may be electrically coupled to other electronic accessory devices, including but not limited to a mini fan for cooling the mobile electronic device 100, a battery or a battery charger that serves as an add-on power source for the mobile electronic device 100 or for powering other devices, a mini display for presenting visual information to a user, a device tracker such as AIRTAG for locating the mobile electronic device 100, an auxiliary speaker external to the mobile electronic device 100, etc. As an example and not by way of limitation, when coupled with a battery, during wireless charging of the mobile electronic device 100, the wireless power transmitter 102 may charge the mobile electronic device 100 normally, but the excess or uncoupled wireless power may be collected by the intermediate receiver coil 302 and used to charge the battery. As an example and not by way of limitation, the battery may be connected to the intermediate receiver coil 302, e.g., via conductive wires. As an example and not by way of limitation, the battery may be received by the base 502 having the intermediate receiver coil 302. As an example and not by way of limitation, the battery may be coupled to or integrated into other accessory devices associated with the mobile electronic device 100 such as a case or a grip. In particular embodiments, the battery may be used as an emergency power source for the mobile electronic device 100 for providing extra battery capacity, or to power some other peripheral devices associated with the mobile electronic device 100, such as notification LEDs, antennas (Bluetooth), wireless earbuds, Bluetooth remote, game controller, etc. In particular embodiments, these electronic accessory devices may receive electric power from the intermediate receiver coil 302. Additionally or alternatively, in particular embodiments, the electronic accessory devices may be powered by a power-share feature of the mobile electronic device 100 or a near-field communication (NFC) signal generated by the mobile electronic device 100.

In particular embodiments, the intermediate receiver coil 302 may be electrically coupled, for example, in parallel as illustrated, to one or more circuit components 706. As an example and not by way of limitation, the circuit components 706 may include but not limited to a rectifier for converting AC produced by the intermediate receiver coil 302 to DC that is suitable for the downstream electronic accessory devices, a voltage regulator for maintaining a constant voltage for the electronic accessory devices, a comparator for comparing an output voltage from the intermediate receiver coil 302 and an input voltage to the electronic accessory devices, and other suitable circuit components. In particular embodiments, one or more of the circuit components 706 may be configured to protect the electronic accessory devices or other devices in the circuit system connected with the intermediate receiver coil 302 from variable power input that may be generated by the intermediate receiver coil 302. Additionally or alternatively, one or more of the circuit components 706 may help tune the inductance of the system to avoid interference with the main charging event of the mobile electronic device 100 by the wireless power transmitter 102 and maintain proper energy transmission therebetween.

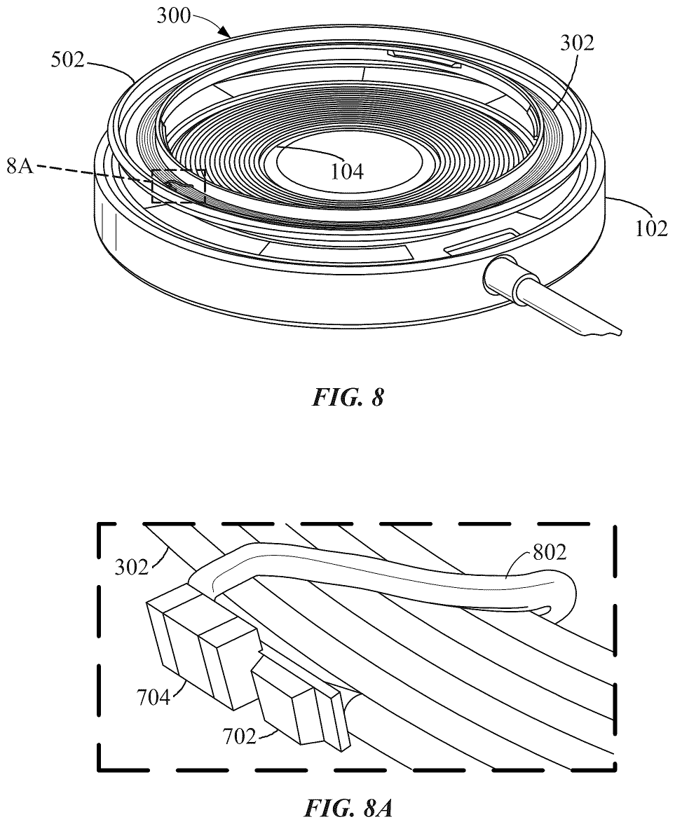

FIGS. 8 and 8A illustrate the intermediate receiver 300 having the LED element 702 and the current-limiting resistor 704 in accordance with an embodiment of this disclosure. In particular embodiments, the LED element 702 and the current-limiting resistor 704 may be housed inside the base 502, for example, such as within the annular groove 504 where the intermediate receiver coil 302 is located. In particular embodiments, the LED element 702 and the current-limiting resistor 704 may be electrically coupled to the intermediate receiver coil 302 via a lead 802. As an example and not by way of limitation, the lead 802 may be a conductive wire extending from the intermediate receiver coil 302 and configured to electrically couple circuit components or other accessory devices with the intermediate receiver coil 302 for power transmission. In particular embodiments, the base 502 may be sealed from the outside to provide electrical insulation and protect the internal components (e.g., the intermediate receiver coil 302 as well as other electronic parts) of the intermediate receiver 300 from contamination (such as dust, moisture, etc.) and exposure to the external environment. Although this disclosure describes an intermediate receiver having a particular circuit component and electronic accessory device in a particular manner, this disclosure contemplates intermediate receivers having any suitable circuit components and electronic accessory devices in any suitable manner.

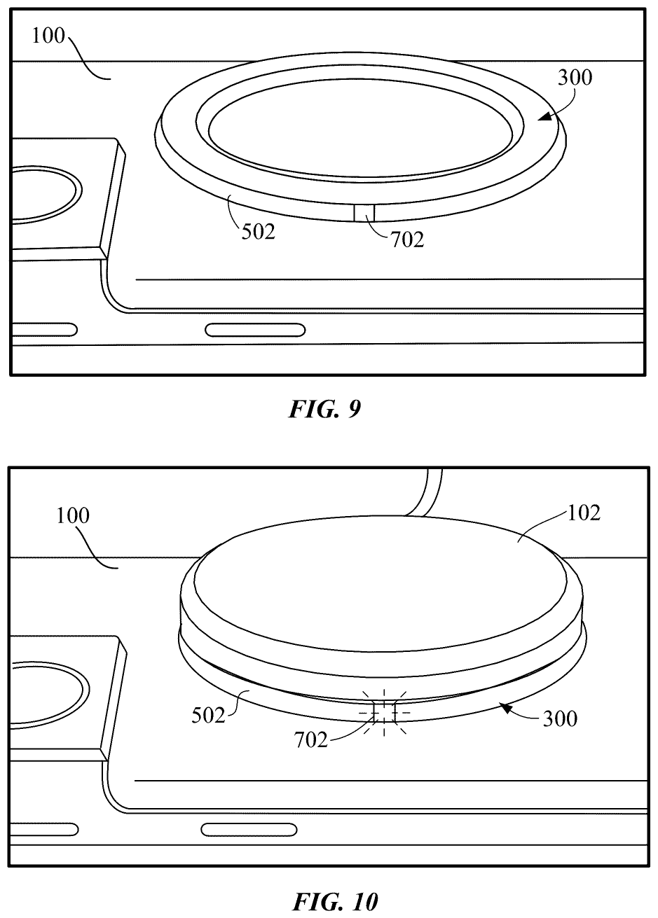

FIGS. 9 and 10 illustrate the intermediate receiver 300, which is coupled to the back of the mobile electronic device 100, in accordance with an embodiment of this disclosure. Although the intermediate receiver 300 is shown as directly attached to the mobile electronic device 100, in particular embodiments, as already explained, the intermediate receiver 300 may alternatively be coupled to or integrated into an accessory device associated with the mobile electronic device 100, for example, such as a grip, a case, a wallet, a stand, or other suitable accessories for coupling to the mobile electronic device 100. In particular embodiments, during wireless charging, the intermediate receiver 300 may sit between the mobile electronic device 100 and the wireless power transmitter 102 to harvest the uncoupled magnetic flux from the wireless power transmitter 102. As an example and not by way of limitation, during energy harvesting, the LED element 702 of the intermediate receiver 300 may be lit, indicating successful coupling between the intermediate receiver 300 and the wireless power transmitter 102.

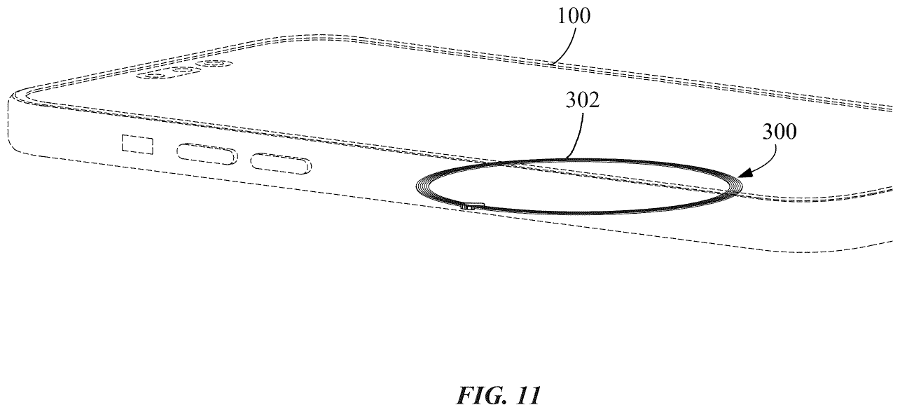

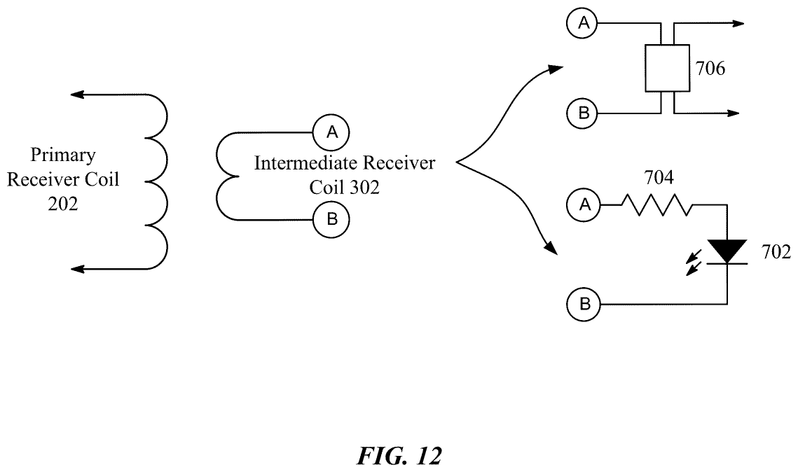

FIGS. 11 and 12 illustrate the intermediate receiver 300 in accordance with an embodiment of this disclosure. In particular embodiments, the intermediate receiver 300 may be configured to receive wireless power from the mobile electronic device 100. As an example and not by way of limitation, the mobile electronic device 100 may be configured with a power-share function, which may also be known as reverse wireless charging, for providing wireless power to the intermediate receiver 300 or other electronic devices. Specifically, in particular embodiments, during power sharing, the primary receiver coil 202 of the mobile electronic device 100 may function in a way similar to a transmitter coil. As an example and not by way of limitation, the primary receiver coil 202 may receive an AC signal (e.g., from a battery of the mobile electronic device 100), which may generate an alternating magnetic field around the primary receiver coil 202. In particular embodiments, the intermediate receiver 300 may be configured to capture the magnetic field via its intermediate receiver coil 302 and convert the captured energy into electric power, thereby powering one or more accessory electronic devices. In particular embodiment, the intermediate receiver 300 may be configured to communicate with the mobile electronic device 100, for example, to negotiate a specified amount of wireless power to be received. As an example and not by way of limitation, the intermediate receiver coil 302 may be the only device receiving wireless power from the primary receiver coil 202. As another example, the intermediate receiver coil 302 may receive an amount of wireless power that is less than, the same, or more than the amount of wireless power that another device is receiving from the primary receiver coil 202. As an example and not by way of limitation, the amount of wireless power received by the intermediate receiver coil 302 may be sufficient to power one or more accessory electronic devices, while avoiding overheating the battery of the mobile electronic device 100 or causing damage to other components in the system. As an example and not by way of limitation, the amount of wireless power received by the intermediate receiver coil 302 may be less than a threshold amount for triggering FOD of the mobile electronic device 100, thus preventing the power-share function from unintentionally being ceased or reduced to a lower output level. In particular embodiments, the intermediate receiver 300 itself may be configured with FOD functionality. As an example and not by way of limitation, the intermediate receiver 300 may be able to detect if there exists a power mismatch between the intermediate receiver 300 and the mobile electronic device 100, indicating possible presence of a foreign object. If so, as an example and not by way of limitation, the intermediate receiver 300 may communicate with the mobile electronic device 100 to adjust or terminate power sharing. In particular embodiments, the intermediate receiver 300 may be configured with one or more coils that are suitable for NFC technology. As an example and not by way of limitation, the intermediate receiver 300 may be configured to receive the NFC signal emitted from the mobile electronic device 100, which may be used for data exchange, device authentication and pairing, etc. As an example and not by way of limitation, the NFC signal may also be used for low-power power sharing with the intermediate receiver 300, for example, to power small electronics that need a relatively low power level.

### Recitation of Embodiments

Embodiment 1. An intermediate receiver of wireless power transfer for coupling to a mobile electronic device, the intermediate receiver comprising: an intermediate receiver coil configured in proximity to a primary receiver coil of the mobile electronic device, the primary receiver coil being configured to receive a primary amount of wireless power from a primary transmitter coil of a wireless power transmitter; wherein the intermediate receiver coil is configured to receive an amount of wireless power from the primary transmitter coil that is less than the primary amount of wireless power received by the primary receiver coil.

Embodiment 2. The intermediate receiver of Embodiment 1, wherein the amount of wireless power received by the intermediate receiver coil is less than a threshold amount for triggering Foreign Object Detection (FOD) between the wireless power transmitter and the mobile electronic device.

Embodiment 3. The intermediate receiver of any one of Embodiments 1-2, wherein the amount of wireless power received by the intermediate receiver coil is less than about 5% of the wireless power transmitted from the primary transmitter coil.

Embodiment 4. The intermediate receiver of any one of Embodiments 1-3, wherein the amount of wireless power received by the intermediate receiver coil is less than about 750 mW.

Embodiment 5. The intermediate receiver of any one of Embodiments 1-4, wherein the intermediate receiver coil is configured between the primary transmitter coil and the primary receiver coil.

Embodiment 6. The intermediate receiver of any one of Embodiments 1-5, wherein the intermediate receiver coil is configured outside a perimeter of the primary receiver coil.

Embodiment 7. The intermediate receiver of any one of Embodiments 1-6, wherein the intermediate receiver coil is configured concentrically with the primary receiver coil.

Embodiment 8. The intermediate receiver of any one of Embodiments 1-7, wherein the intermediate receiver is integrated into one or more accessory devices for coupling to the mobile electronic device.

Embodiment 9. The intermediate receiver of Embodiment 8, wherein the accessory devices comprise one or more of a grip, a case, a wallet, or a stand.

Embodiment 10. The intermediate receiver of any one of Embodiments 1-9, further comprising: a flexible substrate comprising an adhesive and configured to be coupled to the mobile electronic device via the adhesive, wherein the intermediate receiver coil is integrated into the flexible substrate.

Embodiment 11. The intermediate receiver of any one of Embodiments 1-10, further comprising: one or more electronic accessory devices electrically coupled to the intermediate receiver coil, wherein one or more of the electronic accessory devices are configured to receive an electric power from the intermediate receiver coil.

Embodiment 12. The intermediate receiver of Embodiment 11, wherein the electronic accessory devices comprise one or more of a light-emitting diode (LED) element, a fan, a battery, a battery charger, a display, a device tracker, or a speaker.

Embodiment 13. The intermediate receiver of any one of Embodiments 11-12, wherein one or more of the electronic accessory devices are further configured to be powered by a wireless power from the mobile electronic device.

Embodiment 14. The intermediate receiver of any one of Embodiments 11-13, further comprising: a current limiting resistor electrically coupled between the intermediate receiver coil and one or more of the electronic accessory devices and configured to limit an electric current from the intermediate receiver coil to one or more of the electronic accessory devices.

Embodiment 15. The intermediate receiver of any one of Embodiments 11-14, further comprising: a rectifier electrically coupled between the intermediate receiver coil and one or more of the electronic accessory devices and configured to convert an alternate electric current from the intermediate receiver coil into a direct electric current to be received by one or more of the electronic accessory devices.

Embodiment 16. The intermediate receiver of any one of Embodiments 11-15, further comprising: a voltage regulator electrically coupled between the intermediate receiver coil and one or more of the electronic accessory devices and configured to adjust an electric voltage from the intermediate receiver coil to a constant value for one or more of the electronic accessory devices.

Embodiment 17. The intermediate receiver of any one of Embodiments 1-16, wherein the intermediate receiver is further configured to receive an amount of wireless power from the primary receiver coil of the mobile electronic device during power sharing of the mobile electronic device.

Embodiment 18. An intermediate receiver of wireless power transfer for coupling to a mobile electronic device, the intermediate receiver comprising: an intermediate receiver coil configured in proximity to a primary receiver coil of the mobile electronic device, the primary receiver coil being configured to receive a primary amount of wireless power from a primary transmitter coil of a wireless power transmitter; and one or more electronic accessory devices electrically coupled to the intermediate receiver coil and configured to receive an electric power from the intermediate receiver coil; wherein the intermediate receiver coil is configured to receive an amount of wireless power from the primary transmitter coil that is less than the primary amount of wireless power received by the primary receiver coil, and convert the received wireless power into the electric power to be received by one or more of the electronic accessory devices.

Embodiment 19. The intermediate receiver of Embodiment 18, wherein the amount of wireless power received by the intermediate receiver coil is less than a threshold amount for triggering Foreign Object Detection (FOD) between the wireless power transmitter and the mobile electronic device.

Embodiment 20. The intermediate receiver of and one of Embodiments 18-19, wherein the electronic accessory devices comprise one or more of a light-emitting diode (LED) element, a fan, a battery, a battery charger, a display, a device tracker, or a speaker.

Embodiment 21. An intermediate receiver of wireless power transfer for coupling to a mobile electronic device, the intermediate receiver comprising: an intermediate receiver coil configured in proximity to a primary receiver coil of the mobile electronic device, the primary receiver coil being configured to receive a primary amount of wireless power from a primary transmitter coil of a wireless power transmitter; and a base that receives the intermediate receiver coil; wherein the intermediate receiver coil is configured to receive an amount of wireless power from the primary transmitter coil that is less than the primary amount of wireless power received by the primary receiver coil, wherein the base is configured to be integrated into an accessory device for coupling to the mobile electronic device.

Embodiment 22. The intermediate receiver of Embodiments 21, wherein the amount of wireless power received by the intermediate receiver coil is less than a threshold amount for triggering Foreign Object Detection (FOD) between the wireless power transmitter and the mobile electronic device.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. An intermediate receiver of wireless power transfer for coupling to a mobile electronic device, the intermediate receiver comprising:
an intermediate receiver coil configured in proximity to a primary receiver coil of the mobile electronic device, the primary receiver coil being configured to receive a primary amount of wireless power from a primary transmitter coil of a wireless power transmitter;
wherein the intermediate receiver coil is configured to receive an amount of wireless power from the primary transmitter coil that is less than the primary amount of wireless power received by the primary receiver coil.

2. The intermediate receiver of claim 1, wherein the amount of wireless power received by the intermediate receiver coil is less than a threshold amount for triggering Foreign Object Detection (FOD) between the wireless power transmitter and the mobile electronic device.

3. The intermediate receiver of claim 1, wherein the amount of wireless power received by the intermediate receiver coil is less than about 5% of the wireless power transmitted from the primary transmitter coil.

4. The intermediate receiver of claim 1, wherein the amount of wireless power received by the intermediate receiver coil is less than about 750 mW.

5. The intermediate receiver of claim 1, wherein the intermediate receiver coil is configured between the primary transmitter coil and the primary receiver coil.

6. The intermediate receiver of claim 1, wherein the intermediate receiver coil is configured outside a perimeter of the primary receiver coil.

7. The intermediate receiver of claim 1, wherein the intermediate receiver coil is configured concentrically with the primary receiver coil.

8. The intermediate receiver of claim 1, wherein the intermediate receiver is integrated into one or more accessory devices for coupling to the mobile electronic device.

9. The intermediate receiver of claim 8, wherein the accessory devices comprise one or more of a grip, a case, a wallet, or a stand.

10. The intermediate receiver of claim 1, further comprising:
a flexible substrate comprising an adhesive and configured to be coupled to the mobile electronic device via the adhesive, wherein the intermediate receiver coil is integrated into the flexible substrate.

11. The intermediate receiver of claim 1, further comprising:
one or more electronic accessory devices electrically coupled to the intermediate receiver coil, wherein one or more of the electronic accessory devices are configured to receive an electric power from the intermediate receiver coil.

12. The intermediate receiver of claim 11, wherein the electronic accessory devices comprise one or more of a light-emitting diode (LED) element, a fan, a battery, a battery charger, a display, a device tracker, or a speaker.

13. The intermediate receiver of claim 11, wherein one or more of the electronic accessory devices are further configured to be powered by a wireless power from the mobile electronic device.

14. The intermediate receiver of claim 11, further comprising:
a current limiting resistor electrically coupled between the intermediate receiver coil and one or more of the electronic accessory devices and configured to limit an electric current from the intermediate receiver coil to one or more of the electronic accessory devices.

15. The intermediate receiver of claim 11, further comprising:
a rectifier electrically coupled between the intermediate receiver coil and one or more of the electronic accessory devices and configured to convert an alternate electric current from the intermediate receiver coil into a direct electric current to be received by one or more of the electronic accessory devices.

16. The intermediate receiver of claim 11, further comprising:
a voltage regulator electrically coupled between the intermediate receiver coil and one or more of the electronic accessory devices and configured to adjust an electric voltage from the intermediate receiver coil to a constant value for one or more of the electronic accessory devices.

17. The intermediate receiver of claim 1, wherein the intermediate receiver is further configured to receive an amount of wireless power from the primary receiver coil of the mobile electronic device during power sharing of the mobile electronic device.

18. An intermediate receiver of wireless power transfer for coupling to a mobile electronic device, the intermediate receiver comprising:
an intermediate receiver coil configured in proximity to a primary receiver coil of the mobile electronic device, the primary receiver coil being configured to receive a primary amount of wireless power from a primary transmitter coil of a wireless power transmitter; and
one or more electronic accessory devices electrically coupled to the intermediate receiver coil and configured to receive an electric power from the intermediate receiver coil;
wherein the intermediate receiver coil is configured to receive an amount of wireless power from the primary transmitter coil that is less than the primary amount of wireless power received by the primary receiver coil, and convert the received wireless power into the electric power to be received by one or more of the electronic accessory devices.

19. The intermediate receiver of claim 18, wherein the amount of wireless power received by the intermediate receiver coil is less than a threshold amount for triggering Foreign Object Detection (FOD) between the wireless power transmitter and the mobile electronic device.

20. The intermediate receiver of claim 18, wherein the electronic accessory devices comprise one or more of a light-emitting diode (LED) element, a fan, a battery, a battery charger, a display, a device tracker, or a speaker.

21. An intermediate receiver of wireless power transfer for coupling to a mobile electronic device, the intermediate receiver comprising:
an intermediate receiver coil configured in proximity to a primary receiver coil of the mobile electronic device, the primary receiver coil being configured to receive a primary amount of wireless power from a primary transmitter coil of a wireless power transmitter; and
a base that receives the intermediate receiver coil;
wherein the intermediate receiver coil is configured to receive an amount of wireless power from the primary transmitter coil that is less than the primary amount of wireless power received by the primary receiver coil, wherein the base is configured to be integrated into an accessory device for coupling to the mobile electronic device.

22. The intermediate receiver of claim 21, wherein the amount of wireless power received by the intermediate receiver coil is less than a threshold amount for triggering Foreign Object Detection (FOD) between the wireless power transmitter and the mobile electronic device.
